(19) United States
(12) Patent Application Publication
(10) Pub. No.: US 2025/0196368 A1
(43) Pub. Date: Jun. 19, 2025

(54) MAGNETIC GRIPPER

(71) Applicant: Liebherr-Verzahntechnik GmbH, Kempten (DE)

(72) Inventor: Jürgen GROSS, Marbach am Neckar (DE)

(21) Appl. No.: 18/978,996

(22) Filed: Dec. 12, 2024

(30) Foreign Application Priority Data
Dec. 15, 2023 (DE) 10 2023 135 329.2

(51) Int. Cl. B25J 15/02; B25J 15/00; B25J 15/06

(52) U.S. Cl. CPC B25J 15/0246; B25J 15/0608; B25J 15/0052

(57) ABSTRACT

The present disclosure discloses a magnetic gripper comprising a switchable magnetic flux source, two pole pieces, which are magnetically connected to the magnetic flux source, and at least two gripper elements, which are each magnetically conductively connected to one of the two pole pieces, wherein the at least two gripper elements are movably and/or deformably arranged on the magnetic gripper when the magnetic flux source is switched off, such that their front surfaces form a gripping contour, which can be adapted to the contour of an object to be gripped. It is provided here that the magnetic gripper comprises an insulation, which surrounds the at least two gripper elements and magnetically insulates them to the side.

### CROSS REFERENCE TO RELATED APPLICATION

The present application claims priority to German Patent Application No. 10 2023 135 329.2 filed on Dec. 15, 2023. The entire contents of the above-listed application are hereby incorporated by reference for all purposes.

### TECHNICAL FIELD

The present disclosure relates to a magnetic gripper comprising a switchable magnetic flux source, two pole pieces, which are magnetically connected to the magnetic flux source, and at least two gripper elements, which are each magnetically conductively connected to one of the two pole pieces.

### BACKGROUND

Magnetic grippers are used in many applications to grip soft-magnetic objects. If the two gripper elements are resting on the soft-magnetic object and are therefore magnetically conductively connected thereby, this results in a magnetic circuit, through which a magnetic flux passes when the magnetic flux source is switched on. This results in a holding force between the gripper elements and the soft-magnetic object.

### SUMMARY

WO 2023/191914 A1 discloses a magnetic gripper in which soft-magnetic gripper pins are used, which are movably mounted in holes in the pole pieces in a spring-loaded manner and can therefore yield when the magnetic gripper is placed onto an object in order to thus form a gripping contour adapted to the contour of the object to be gripped.

However, using the solution disclosed in WO 2023/191914 A1, it is not reliably possible to grip objects such that they could be removed from a container in which they are contained in a disordered manner by means of the magnetic gripper with sufficient certainty, for example.

The object of the present disclosure is therefore to provide an improved magnetic gripper.

This object is achieved by means of the magnetic gripper of the present disclosure.

In a first independent aspect, the present disclosure comprises a magnetic gripper comprising a switchable magnetic flux source, two pole pieces, which are magnetically connected to the magnetic flux source, and at least two gripper elements, which are each magnetically conductively connected to one of the two pole pieces, wherein the at least two gripper elements are movably and/or deformably arranged on the magnetic gripper when the magnetic flux source is switched off, such that their front surfaces form a gripping contour, which can be adapted to the contour of an object to be gripped. The first aspect is characterized in that the magnetic gripper comprises an insulation, which surrounds the at least two gripper elements and magnetically insulates them to the side.

The inventor of the present disclosure has recognized that, in the solution disclosed in WO 2023/191914 A1, it is therefore also not possible to reliably grip individual objects because the front surface of the gripper pins not only exerts a magnetic attraction force on the soft-magnetic objects to be gripped, but also on the side surfaces of the gripper pins, such that, in addition to the object which is supposed to be gripped, other objects often also adhere to the gripper fingers or are at least moved therewith, and therefore shear off the object to be gripped.

By means of the insulation according to the disclosure, which surrounds the at least two gripper elements and magnetically insulates them to the side, other objects are prevented from adhering to the side in this way, and therefore the gripping properties of the magnetic gripper are decisively improved.

In this case, the insulation can surround each of the gripper elements individually and/or can surround the entirety of the gripper elements. It leaves at least the front surfaces of the gripper elements free in any case, however, such that they can still form a gripping contour.

According to a possible configuration of the present disclosure, the insulation is first of all used such that objects cannot come into contact with the soft-magnetic material of the gripper elements at the side, and therefore gripping forces, by means of which the objects could adhere, do not arise owing to the distance from the soft-magnetic material of the gripper elements, either. Furthermore, the insulation itself must not generate any gripping forces, i.e. it must not be magnetically conductively connected to the magnetic flux source in any case.

According to a possible configuration of the present disclosure, the insulation comprises a non-magnetic and/or magnetically insulating material. In particular, at least the outside of the insulation consists of a non-magnetic and/or magnetically insulating material. For example, aluminum, plastics material and/or rubber can be used as a non-magnetic and/or magnetically insulating material.

According to a possible configuration of the present disclosure, in this case the magnetic gripper is configured such that the gripper elements can be fixed in their position and/or shape, in particular by applying a magnetic field by way of switching on and/or partially switching on the magnetic flux source.

In this case, the magnetic gripper is optionally configured such that the magnetic flux source is only partially switched off after gripping and the magnetic gripper therefore retains the gripping contour. The strength of the magnetic field generated by the magnetic flux source is therefore reduced after the gripping to such an extent that the remaining gripping force is too low to grip the object but is sufficient to fix the gripper elements in their position and/or shape.

The shape and/or position of the gripper elements and therefore the gripping contour defined by their front surfaces can be saved in this way, such that the magnetic gripper can be equipped with a gripping geometry that is specifically adapted to a workpiece and does not change during operation.

In particular, the gripping contour of the magnetic gripper can therefore either be externally preformed or the shape of the first object gripped can be retained. The gripping of all (further) objects by means of this gripping contour is then optionally performed in the correct position relative to the object, which is predefined by the gripping contour.

According to a possible configuration of the present disclosure, the insulation is movably and/or deformably arranged on the magnetic gripper at least when the magnetic flux source is switched off. This not only allows the front surfaces of the gripper elements to form a gripping contour which can be adapted to the contour of an object to be gripped, but also allows the insulation to be adapted to the contour of the object to be gripped and/or the position and/or the deformation state of the gripper elements and therefore allows the gripper elements to be reliably insulated at the side independently of their position and/or deformation state.

In particular, the insulation can be movable and/or deformable such that a front surface of the insulation rests on the object to be gripped when it is gripped and/or adapts to the deformation state of the gripper elements.

Possible configurations of the gripper elements and the insulation which can be used in a magnetic gripper according to the disclosure are described in the following.

According to a possible configuration of the present disclosure, the at least two gripper elements are formed by gripper pins, which are movably mounted on the magnetic gripper.

According to a possible configuration of the present disclosure, the gripper pins are linearly movably mounted on the magnetic gripper.

According to a possible configuration of the present disclosure, the gripper pins are preloaded into an extended position by spring elements.

In an alternative configuration, the gripper pins are mounted on the magnetic gripper without preload and are extended from the magnetic gripper by their weight force.

According to a possible configuration of the present disclosure, the insulation is formed by insulating pins, which are movably mounted on the magnetic gripper and surround the gripper elements. In particular, the insulating pins therefore form an insulation which is movably mounted on the magnetic gripper, surrounds the gripper pins and therefore separates the gripper pins from the components to be gripped outwards at the side.

According to a possible configuration of the present disclosure, the insulating pins are linearly movably mounted on the magnetic gripper. In particular, in this case, the insulating pins are movable in the same direction as the gripper pins, if the gripper elements are formed by movable gripper pins.

According to a possible configuration of the present disclosure, the insulating pins are preloaded into an extended position by spring elements.

According to a possible configuration of the present disclosure, the insulating pins each comprise an insulating sleeve, which surrounds a soft-magnetic core and magnetically insulates it to the side. Therefore, the insulating pins additionally also have a gripping function in addition to their insulating function.

According to a possible configuration of the present disclosure, the insulation is formed such that the gripper pins each comprise an insulating sleeve, which surrounds a soft-magnetic core and magnetically insulates it to the side. In particular, for this purpose, the insulating sleeve consists of a magnetically insulating material. In this configuration, the individual gripper pins themselves comprise an insulation. In this case, the insulation is optionally rigidly connected to the soft-magnetic core and therefore, when the gripper pin moves, it moves with it.

In this configuration, the insulation is therefore movably arranged on the magnetic gripper in that it is movable together with the individual gripper pins.

In a possible configuration, the gripper elements of the present disclosure can be deformably arranged on the magnetic gripper when the magnetic flux source is switched off and in particular can each comprise a deformable front surface, which forms a gripping contour, which can be adapted to the contour of an object to be gripped.

In this case, the present disclosure also relates to this configuration independently of the use of an insulation as has been claimed in the first aspect.

In a second independent aspect, the present disclosure therefore comprises a magnetic gripper comprising a switchable magnetic flux source, two pole pieces, which are magnetically connected to the magnetic flux source, and at least two gripper elements, which are each magnetically conductively connected to one of the two pole pieces. The second aspect is characterized in that the at least two gripper elements comprise a deformable front surface when the magnetic flux source is switched off, which front surface forms a gripping contour, which can be adapted to the contour of an object to be gripped. By means of this configuration, the gripping contour is therefore in contact with the contour of an object to be gripped not only at points, but over the surface. As a result, greater gripping forces are possible. Furthermore, the grip is better secured against lateral shearing.

According to a possible configuration of the present disclosure, in this case the magnetic gripper is configured such that the gripper elements and in particular their front surfaces can be fixed in their shape, in particular by applying a magnetic field by way of switching on and/or partially switching on the magnetic flux source. The shape of the gripper elements and in particular their front surfaces can be saved in this way, such that the magnetic gripper can be equipped with a gripping geometry that is specifically adapted to a workpiece and does not change during operation.

In this case, the gripper elements and/or their front surfaces optionally consist of a soft-magnetic material, such that the gripper elements resting on the object to be gripped by their front surfaces form a closed magnetic circuit made of soft-magnetic material with the object.

According to a possible configuration of the present disclosure, the at least two gripper elements are formed by flexible sleeves, which are filled with a soft-magnetic granulate. As a result, with no magnetic field being applied, the gripper elements can adapt to the contour of the object to be gripped.

When the magnetic flux is switched on, however, it fixes the granules of the soft-magnetic granulate to one another. When the magnetic flux source is partially switched off, the magnetic field optionally drops only to the extent that although the object is no longer gripped, the granules still remain fixed to one another such that the magnetic gripper retains its gripping contour.

The soft-magnetic granulate can be pellets and/or angular granules. If angular granules are used, this requires the granules to interlock with one another when the magnetic flux source is switched on.

The front surface of the gripper elements and/or the flexible sleeve of the gripper elements is optionally made of soft-magnetic material.

The front surface of the gripper elements and/or the flexible sleeve of the gripper elements can for example be made of a wire mesh and/or a chain-mail material.

According to a possible configuration of the present disclosure, pole pins extend into the granulate. As a result, the magnetic flux is particularly effectively conducted from the pole pieces into the granulate and from there into the object to be gripped. In particular, this reduces the path between the pole piece and the object to be gripped that has to be spanned by the granulate and thus increases the gripping force.

In a first configuration, the pole pins can be rigidly arranged on the magnetic gripper.

In a second configuration, the pole pins are movably arranged on the magnetic gripper. In particular, they are linearly movably mounted on the magnetic gripper and/or preloaded into an extended position on the magnetic gripper. The pole pieces therefore push into the granulate and therefore ensure that the flexible sleeve of the gripper elements is always full enough and/or the distance from the component to be gripped is reduced, which increases the gripping force, since a shorter distance results in a higher gripping force.

The present disclosure relates to the magnetic gripper according to the second aspect initially independently of the first aspect. In particular, the magnetic gripper according to the second aspect can therefore be designed without side insulation of the gripper elements.

Optionally, however, the second aspect is combined with the first aspect, i.e. the magnetic gripper according to the second aspect comprises an insulation which surrounds the gripper elements at the side.

According to a possible configuration, in this case, insulating pins as already described above with respect to the first aspect are arranged on the magnetic gripper and surround the deformable gripper elements.

Configurations which, unless otherwise stated, can be used both with the first and the second aspect per se, and in combinations of these aspects, are described in the following.

According to a possible configuration of the present disclosure, the insulation is formed by at least one flexible element, which surrounds the gripper elements at the side. In this configuration, the insulation is therefore (also) deformable.

According to a possible configuration of the present disclosure, the insulation is formed by a bellows, which surrounds the gripper elements. According to a possible configuration, a negative pressure can be applied to the interior of the bellows, which negative pressure fixes it to the contour of the object to be gripped in the manner of a suction gripper.

According to a possible configuration of the present disclosure, the insulation is formed by a flexible sleeve, which forms a magnetic insulating layer and surrounds the gripper elements at the side.

In a combination of the first and the second aspect, the flexible sleeves of the gripper elements containing the granulate can form an insulating layer on their side surfaces or can be equipped with a magnetic insulating layer.

Alternatively, a flexible sleeve can also be provided which surrounds the plurality of gripper elements together as a group.

In the configuration according to the second aspect, an insulation is optionally provided which separates the gripper elements from one another. This prevents the gripper elements from becoming attached to one another owing to their deformability, such that a magnetic short circuit is produced.

The insulation separating the gripper elements from one another is optionally deformably and/or movably arranged on the magnetic gripper and therefore does not impair the deformation of the gripper elements.

If the flexible sleeves of the gripper elements are equipped with an insulation, this simultaneously also forms insulation of the gripper elements from one another.

If, however, an insulation is provided which surrounds the plurality of gripper elements together as a group, an insulation is optionally additionally provided which separates the gripper elements from one another and can for example be designed as a flexible partition wall, for example of a flexible bellows, or as movable insulating pins, in particular those that have been described with respect to the first aspect.

As described above, the gripper elements according to the first aspect can be formed by gripper pins, which are linearly movably arranged on the magnetic gripper.

According to a possible configuration of the present disclosure, in this case the gripper pins each comprise a guide element, by means of which they are linearly movably guided on the magnetic gripper.

According to a possible configuration of the present disclosure, the guide elements of at least two adjacent gripper pins are guided directly on one another. This provides a more compact arrangement, greater flow cross sections and simpler producibility.

According to a possible configuration, a plurality of gripper pins arranged beside one another are assigned to at least one pole piece, the guide elements of which pins are guided on a side wall of the pole piece. This again provides a more compact arrangement, greater flow cross sections and simpler producibility.

The present disclosure also relates to this configuration, however, independently of the first aspect.

In a third independent aspect, the present disclosure therefore comprises a magnetic gripper comprising a switchable magnetic flux source, two pole pieces, which are magnetically connected to the magnetic flux source, and at least two gripper elements, which are each magnetically conductively connected to one of the two pole pieces, wherein the at least two gripper elements are movably arranged on the magnetic gripper when the magnetic flux source is switched off, such that their front surfaces form a gripping contour, which can be adapted to the contour of an object to be gripped, wherein the at least two gripper elements are formed by gripper pins, which are linearly movably arranged on the magnetic gripper. The third aspect is characterized in that the gripper pins each comprise a guide element, by means of which they are linearly movably guided on the magnetic gripper. In a first variant, it is provided that the guide elements of at least two adjacent gripper pins are guided directly on one another. In a second variant, it is provided that a plurality of gripper pins arranged beside one another are assigned to at least one pole piece, the guide elements of which pins are guided on a side wall of the pole piece. Both variants provide a more compact arrangement, greater flow cross sections and simpler producibility.

In particular, in this case, the guide elements of the gripper pins form a block of elements, which is arranged in a cut-out in the magnetic gripper that is not divided any further. In this case, magnetic flux is optionally transmitted directly between the guide elements.

The features of the first and the second variant are optionally used in combination.

Configurations which, unless otherwise stated, can be used both with the first and the second variant, and with a combination of the two variants, are described in the following.

According to a possible configuration of the present disclosure, a first group of gripper pins arranged beside one another, the guide elements of which are guided on a side wall of the pole piece, are assigned to at least one pole piece, wherein a second group of gripper pins arranged beside one another, the guide elements of which are guided on the guide elements of the first group, are also assigned to the pole piece. The magnetic flux is therefore guided from the pole piece, via the first group, to the second group of gripper pins.

The present disclosure relates to the third aspect of the present disclosure initially independently of the first aspect of the present disclosure. In particular, the configuration of the gripper pins according to the third aspect can therefore also be used without an insulation according to the first aspect.

Optionally, however, the third aspect is implemented in combination with the first aspect, i.e. the configuration of the gripper pins according to the third aspect is used together with an insulation according to the first aspect.

Configurations of the present disclosure which, unless stated otherwise, can be used in the first, the second or the third aspect, or also in a combination of the second or third aspect with the first aspect, are described in the following.

According to a possible configuration of the present disclosure, the gripper elements are formed by gripper pins, which each comprise a guide element, by means of which they are linearly movably guided on the magnetic gripper.

According to a possible configuration of the present disclosure, the magnetic gripper comprises at least one insulating pin, which comprises a guide element, by means of which it is linearly movably guided on the magnetic gripper.

According to a possible configuration of the present disclosure, the insulating pin is guided via the guide element on one of the pole pieces and/or on guide elements of other insulating pins and/or on guide elements of gripper pins.

According to a possible configuration of the present disclosure, the guide elements of the gripper pins and/or the insulating pins consist of a soft-magnetic material.

The guide elements of the insulating pins can, however, also be made of a non-soft-magnetic material and/or a magnetic insulating material.

According to a possible configuration of the present disclosure, pin elements are arranged on the guide elements of the gripper pins and/or insulating pins, the front surface of said pins forming a gripping surface of the magnetic gripper on the gripper pins.

According to a possible configuration of the present disclosure, the pin elements have a smaller cross section than the guide elements, wherein the pin elements optionally pass through openings in a housing of the magnetic gripper, on which the guide elements are retained.

According to a possible configuration of the present disclosure, the guide elements comprise planar side surfaces, by means of which they are guided on one another and/or on the side surfaces of the pole pieces. This results in considerably larger contact surfaces than in a round configuration.

According to a possible configuration of the present disclosure, the guide elements have a rectangular or hexagonal cross section.

According to a possible configuration of the present disclosure, the magnetic gripper comprises a plurality of gripper pins, the guide elements of which are arranged in a spatial region provided between the two pole pieces. This also results in a compact arrangement and in particular short distances between the gripper pins.

According to a possible configuration of the present disclosure, at least one group of these gripper pins is assigned to each of the two pole pieces, wherein the two groups are optionally separated from one another by a partition wall, which is made of a magnetic insulating material and divides the spatial region into at least two compartments.

According to a possible configuration of the present disclosure, the gripper pins are guided within the at least two compartments only on one another and the side walls of the compartments.

According to a possible configuration of the present disclosure, the magnetic gripper comprises a magnetically insulating enclosure laterally surrounding the magnetic flux source and/or pole shoes and/or the mounting region for the gripper pins of the magnetic gripper. In particular, said enclosure is rigidly arranged on the magnetic gripper and prevents components from adhering to the magnetic gripper in this region.

According to a possible configuration of the present disclosure, the magnetic gripper is configured such that the at least two gripper elements are non-movably and/or non-deformably arranged on the magnetic gripper when the magnetic flux source is switched on and/or partially switched on, such that switching it on and/or partially switching it on fixes the gripping contour formed by the front surfaces of the gripper elements.

Depending on the configuration variant, the magnetic gripper can be configured such that the insulation is likewise non-movably and/or non-deformably arranged on the magnetic gripper when the magnetic flux source is switched on and/or partially switched on, or such that the insulation is also movable and/or deformable when the magnetic flux source is switched on and/or partially switched on.

According to a possible configuration of the present disclosure, the magnetic flux source has at least three switching states, in which the magnetic flux is switched on, switched off and partially switched on. Alternatively or additionally, the magnetic flux source can also be designed such that the magnetic flux can be continuously actuated or switched.

In this case, the gripping force required for the gripping is generated by switching on the magnetic flux source. If the magnetic flux source is only partially switched on, as a result the gripper elements are optionally fixed in their position and/or shape without the gripping force being sufficient to grip an object.

The switchable magnetic flux source can comprise at least one electromagnet and can be switched by applying an electrical voltage to the electromagnet. Alternatively or additionally, the switchable magnetic flux source can comprise at least one permanent magnet and can be switched by mechanically adjusting a component.

According to a possible configuration of the present disclosure, the magnetic gripper comprises a controller, which actuates the switchable magnetic flux source, and is in particular configured to switch it into the above-mentioned switching states.

If gripper pins are used as gripper elements, the magnetic gripper is optionally equipped with at least 6, optionally with at least 10, and more optionally with at least 20 gripper pins.

If deformable gripper elements are used, depending on the object to be gripped, just 2, just 4 or just 6 gripper elements can also be used. Here too, the number of gripper pins can also be greater, however.

The present disclosure also comprises a device for the automated removal of workpieces arranged in a disordered manner in a container, comprising an object-recognition apparatus for detecting the workpieces in the container and a magnetic gripper according to the present disclosure, as has been described above, for gripping and removing the workpieces from the container.

According to a possible configuration of the present disclosure, the device also comprises a handling device, in particular a robot and/or a linear gantry, area gantry and/or room gantry, on which the magnetic gripper is arranged.

According to a possible configuration of the present disclosure, the device comprises a controller for evaluating the data from the object-recognition apparatus, for path planning and for actuating the handling device and/or the magnetic gripper.

In particular, the controller can be configured and/or programmed such that the device carries out one of the methods described above or in the following, in particular carries it out in an automated manner.

The present disclosure also comprises a method for operating a magnetic gripper, as has been described above, comprising the steps of:
moving the magnetic gripper up to an object to be gripped with the magnetic flux source switched off, such that the gripper elements are moved and/or deformed by the contact with the component and form a gripping contour adapted to the component, and
at least partially switching on the magnetic flux source to fix the gripping contour and/or to grip the component.

The method according to the disclosure can optionally be configured as has already been described above with regard to the magnetic gripper according to the disclosure and the device according to the disclosure.

According to a possible configuration, in this case, a predefined contour or an object can initially be contacted (possibly outside the container) in order to provide the magnetic gripper with a preformed gripping contour that allows the object to be securely gripped.

The magnetic force is then partially switched on in order to fix this gripping contour, and always remains at least partially switched on for the following gripping processes in order to retain the gripping contour.

For gripping, the gripper is then moved up to the object to be gripped in the correct position, such that the gripping contour rests on the object and the object is gripped by fully switching on the magnetic flux source and is set down by partially switching it off.

The gripping contour from the first time an object is gripped in the container (learning grip) can also be saved for the following gripping operations (likewise with reduced magnetic force).

According to an alternative approach, however, the magnetic flux source can also be completely switched off after one or more gripping operations, such that the gripper elements are movable and/or deformable again and adapt to the contour of an object to be gripped.

In particular, the magnetic flux source can be completely switched off when none of the objects in the container can be gripped in the correct position by the existing gripping contour. In this case, a different gripping position and therefore a different gripping contour can therefore be used for gripping the next object. The new gripping contour can also be set outside the container or in the container in the next gripping operation.

### BRIEF DESCRIPTION OF THE FIGURES

The present disclosure will now be described in greater detail with reference to exemplary embodiments and drawings, in which:

FIG. 1 is a perspective view of a first exemplary embodiment of the magnetic gripper,

FIG. 2 is a sectional view of the first exemplary embodiment,

FIG. 3 is a front view of the first exemplary embodiment towards the gripping surface,

FIG. 4a shows a possible configuration of an insulating pin and/or gripper pin,

FIG. 4b shows four possible configurations of the front surface of a gripper pin,

FIG. 4c is a perspective view of the fourth configuration of a front surface from FIG. 4b,

FIG. 5a to 5c show three variants of the first exemplary embodiment of a magnetic gripper each having differently configured insulating pins,

FIG. 6 is a partial sectional view of a second exemplary embodiment of the magnetic gripper,

FIG. 7 is a sectional view of a third exemplary embodiment of the magnetic gripper,

FIG. 8 is a sectional view of a fourth exemplary embodiment of the magnetic gripper,

FIG. 9 is a sectional view of a fifth exemplary embodiment of the magnetic gripper, and

FIG. 10 shows an exemplary embodiment of a device according to the disclosure for the automated removal of workpieces arranged in a disordered manner in a container.

### DETAILED DESCRIPTION

In the following, exemplary embodiments of the present disclosure are described which each implement a plurality of aspects of the present disclosure in combination, and in particular disclose either combinations of the first and the second aspect or combinations of the first and the third aspect. The present disclosure also relates to the configurations of the individual aspects described in relation to the exemplary embodiments independently of the other aspects, however, and said configurations can also be implemented without them.

All the exemplary embodiments of the magnetic gripper each comprise a switchable magnetic flux source 11, which is only schematically shown, and two pole pieces 12, which are magnetically connected to the magnetic flux source.

In this case, the pole pieces are rigidly arranged on the magnetic gripper in each of the first and second exemplary embodiments. In the following exemplary embodiments, they can also be movably arranged on the magnetic gripper.

Furthermore, in all the exemplary embodiments, the magnetic gripper comprises at least two gripper elements 20, 120, which are movably and/or deformably arranged on the magnetic gripper when the magnetic flux source is switched off, such that their front surfaces form a gripping contour, which can be adapted to the contour of an object to be gripped.

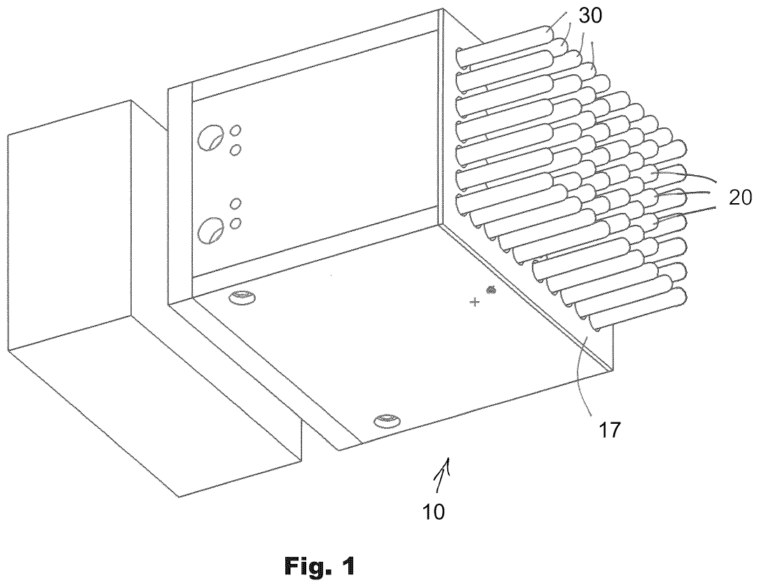

FIG. 1 to 3 show a first exemplary embodiment of a magnetic gripper 10 of this kind.

According to the first aspect of the present disclosure, the magnetic gripper comprises a plurality of insulating pins 30, which are movably mounted on the magnetic gripper, surround the gripper elements 20 and thus magnetically insulate them to the side or separate them from other objects that could be in the region of the object to be gripped. The insulating pins 30 therefore prevent objects from adhering to the side surfaces of the gripper elements. According to a possible configuration, the side surfaces of the gripper elements can therefore be designed to be soft-magnetic or magnetically conductive.

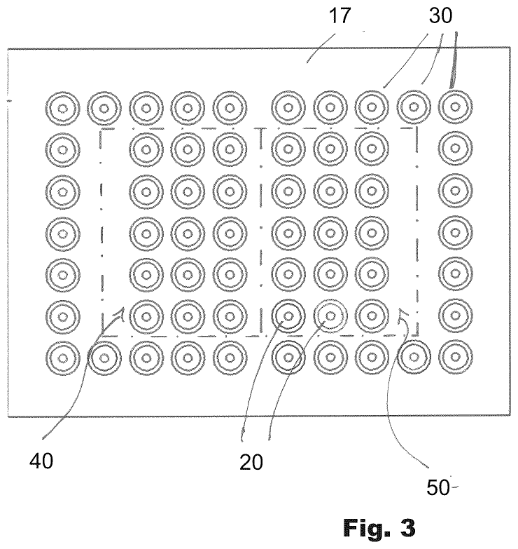

As shown in FIG. 3, the insulating pins 30 form a frame here, which surrounds the gripper elements on all sides.

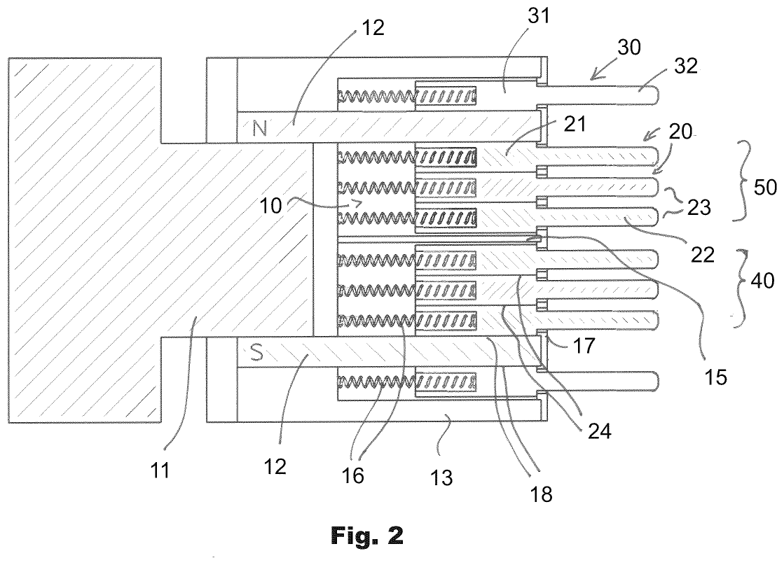

As shown in FIG. 2, the insulating pins 30 are linearly movably guided on the magnetic gripper and are preloaded into a pushed-out position by a spring 16.

In this exemplary embodiment, the insulating pins comprise a guide region 31, which is guided in a cut-out in the magnetic gripper, and a pin region 32, which protrudes from the magnetic gripper in the extended position.

In this exemplary embodiment, the pin region 32 has a smaller cross section than the guide region 31 and passes through a cut-out in a front cover plate 17 of the magnetic gripper, which is smaller than the guide region 31, and therefore retains said guide region in the housing of the magnetic gripper.

Independently of this configuration of the first aspect, the gripper elements in the exemplary embodiment shown in FIG. 1 to 3 are formed by gripper pins 20, which are linearly displaceably mounted on the magnetic gripper. The gripper pins are preloaded into a pushed-out position by springs 16. The gripper pins can, however, also be loosely guided in the magnetic gripper without any preloading.

In this case, the component is gripped by the gripper pins 20 being placed onto the component to be gripped by their front side and thus forming a closed magnetic circuit. Because the gripper pins are movable, they can adapt to the contour of the component here.

In this exemplary embodiment, the gripper pins comprise a guide region 21, which is guided in a cut-out in the magnetic gripper, and a pin region 22, which protrudes from the magnetic gripper in the extended position.

In this exemplary embodiment, the pin region 22 has a smaller cross section than the guide region 21 and passes through a cut-out in a front cover plate 17 of the magnetic gripper, which is smaller than the guide region 21, and therefore retains said guide region in the housing of the magnetic gripper.

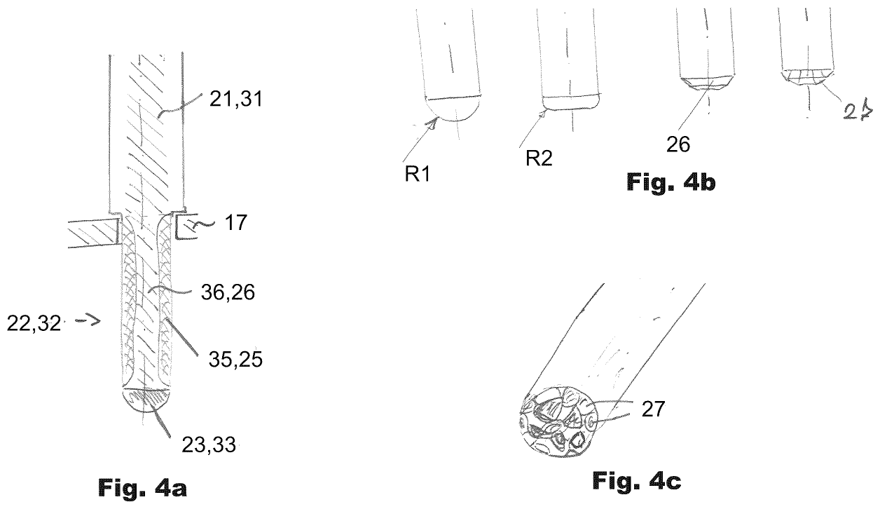

FIG. 4a shows a possible configuration of an insulating pin and/or gripper pin. In this case, the insulating pin and/or gripper pin comprises, in the pin region 22, 32, an insulating sleeve 25, 35 made of a magnetically insulating material, which surrounds a core 26, 36 made of magnetically conductive or soft-magnetic material. By contrast, the guide region 21, 31 consists of magnetically conductive or soft-magnetic material either completely or at least on the outside. Likewise, the tip or front surface 23, 33 consists of magnetically conductive or soft-magnetic material.

If the pin shown in FIG. 4a is used as the insulating pin, it simultaneously also serves as a gripper pin, since it provides a closed magnetic path from the guide region 31, via the core 36, to the front surface 33, over which path a gripping force can be applied to an object to be gripped. At the same time, the insulating sleeve 36 not only insulates the core 36 to the side, but the insulating pin can also insulate gripper pins arranged further inside, which therefore do not require an insulating sleeve, but instead can be fully made of a magnetically conductive or soft-magnetic material.

The pin shown in FIG. 4a can, however, also be used as a gripper pin without dedicated insulating pins being used, since the pin itself is already equipped with an insulation. In particular, in this case, all the gripper pins can comprise an insulating sleeve 35.

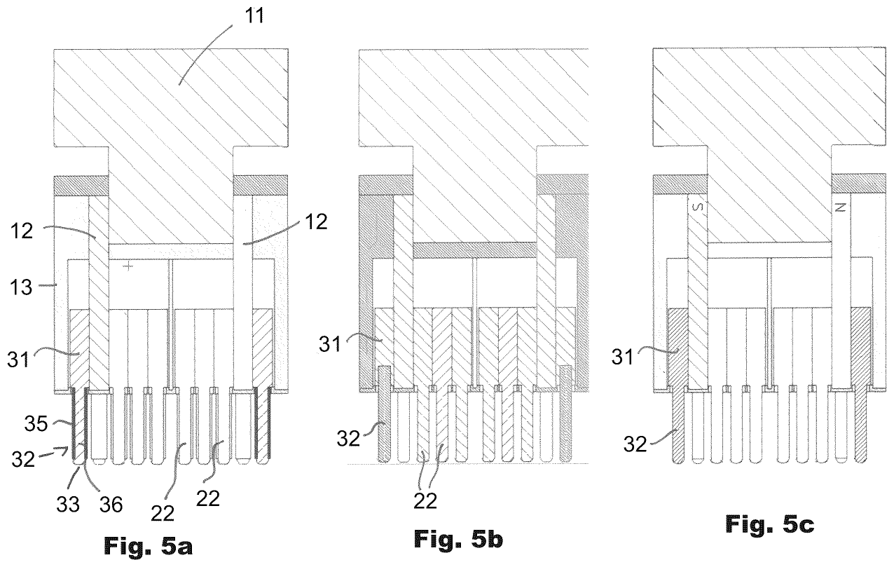

FIG. 5a to 5c then show three variants of the configuration shown in FIG. 1 to 3, in which different insulating pins are used.

In FIG. 5a, the insulating pins comprising an insulating sleeve 35 that are shown in FIG. 3a and described above are used as insulating pins 30. The insulating pins 30 therefore additionally also serve as gripper pins.

In FIG. 5b, the guide region 31 of the insulating pins 30 is made of a magnetically conductive or soft-magnetic material, but the pin region 32 is fully made of a magnetically insulating material.

In FIG. 5c, both the guide region 31 of the insulating pins 30 and the pin region 32, and therefore the entire insulating pin, are made of a magnetically insulating material.

In all three configurations, the gripper pins 20 surrounded by the insulating pins 30 can be designed without an insulating sleeve, i.e. both the pin region 22 and the guide region 21 can be made of a magnetically conductive or soft-magnetic material. They can, however, of course also comprise an insulating sleeve 25.

In the exemplary embodiments shown, the guide regions 31 of at least some insulating pins 30 are guided on an outer side surface 18 of the pole pieces 12 and/or are magnetically connected thereto. As an alternative to the arrangement shown, in which they directly adjoin the pole pieces, the guide regions 31 of the insulating pins 30 could also be guided on the guide regions 21 of a row of gripper elements, which could be arranged between the guide regions 31 of the insulating pins 30 and the outer surface of the pole pieces 12. In this case too, a magnetically conductive connection would be provided via the guide regions 21 of the gripper elements.

When the magnetic flux source is switched on, the guide regions 31 of the insulating pins 30 are therefore magnetically fixed in those variants in FIGS. 5a and 5b in which they consist of a soft-magnetic material. This applies in particular to the configuration in FIG. 5a, since, in this case, the magnetic circuit leads from the pole piece 12, via the guide region 31 and the core 36, to the component to be gripped, and therefore a holding force is also exerted on the guide region 31. In the variant in FIG. 5b, however, the guide region 31 is part of the magnetic cross section of the magnetic circuit only in addition to the pole piece 12, such that the holding force exerted on the guide region 31 is accordingly lower.

Independently of the configuration of the guide regions 31, in this exemplary embodiment, the guide regions of at least some adjacent insulating pins are guided directly on one another. A plurality of insulating pins therefore form a closed row, the guide regions 31 of which are guided in a block in a shared cut-out in the magnetic gripper.

According to the third aspect of the present disclosure, the guide regions 21 of at least some adjacent gripper elements 20 are guided on one another. A plurality of gripper pins therefore form a closed row, the guide regions 21 of which are guided in a block in a shared cut-out in the magnetic gripper. As a result, the magnetic flux is transmitted from one of the guide regions 21 to the next, i.e. the guide regions 21 are also part of the magnetic circuit of adjacent gripper elements.

Likewise, according to the third aspect of the present disclosure, the guide regions 21 of at least some adjacent gripper elements 20 are guided on a side surface 18 and in particular on an inner side surface 18 of a pole piece 12. They are, however, not guided on a pole piece 12 by at least one side surface.

The side surfaces of the guide regions 21 are each designed to be flat, and therefore are in surface contact with the side surfaces 18 of the pole piece or the other guide regions 21. In particular, the guide regions 21 have a rectangular, for example square, cross section. This also applies to the guide regions 31 of the insulating pins.

First of all, this considerably simplifies production. In addition, the material cross section available for conducting the magnetic flux is considerably increased.

As shown in FIGS. 2 and 5a to 5c, in this exemplary embodiment, a plurality of rows of gripper elements 20 are provided, which are assigned to a pole piece, wherein a first row is guided directly on a side wall of the pole piece. The following row or rows is/are, however, guided on a series of gripper elements 20 arranged between them and the pole piece, and the magnetic flux is guided from the pole piece, through the row of gripper elements positioned therebetween, to these rows. The plurality of rows therefore form a block as a whole, which is arranged in a shared cut-out. This results in a very compact configuration.

One or more rows of gripper elements could likewise be guided on the outside of the pole pieces.

As shown in FIGS. 2 and 3, the gripper comprises two groups 40 and 50 of gripper pins, which are each assigned to one of the two pole pieces and are arranged in the region between the two pole pieces 12. In this case, the guide elements 21 in these two groups are magnetically separated from one another by an insulating wall 15, which divides this region into two parts.

The two groups of gripper pins are surrounded by the frame of insulating pins 30 on all sides, as shown in FIG. 3.

FIG. 3a also again shows how the guide region 21, 31 is retained on the front plate 17. However, it is understood that other mechanical configurations are also possible which secure the insulating pins and/or gripper pins on the magnetic gripper, in particular also those that allow the pin region to have the same cross section as the guide region. For example, in this case, the guide region can comprise a slot, through which a securing rod passes.

FIG. 4b shows different configurations of the front surface 23, 33 of a gripper pin and/or insulating pin. In the figure on the far left, the front surface comprises a uniformly curved surface, in particular in the shape of a partial sphere having a defined radius R1. In the second figure from the left, the front surface comprises a flat central portion, which transitions into the side surface via a curved portion, indicated here by a radius R2. In the configuration in the third figure from the left, however, the transition is formed by a partial cone 26. Furthermore, the central part of the front surface can also be formed by a cone. On the far right and in FIG. 4c, a configuration is shown in which the front surface is formed by a plurality of facets that are inclined relative to one another. According to a possible configuration of the present disclosure, the tips of the gripper pins are interchangeable in order for it to be possible to individually adapt the front surfaces of the gripper pins to the object to be gripped.

As shown in FIG. 2, in this exemplary embodiment, the magnetic gripper comprises housing elements 13 made of a magnetically insulating material, which magnetically insulates the magnetic source 11, the pole pieces 12 and/or the guide elements 21 and 31 from the outside, such that no objects adhere in this region, either.

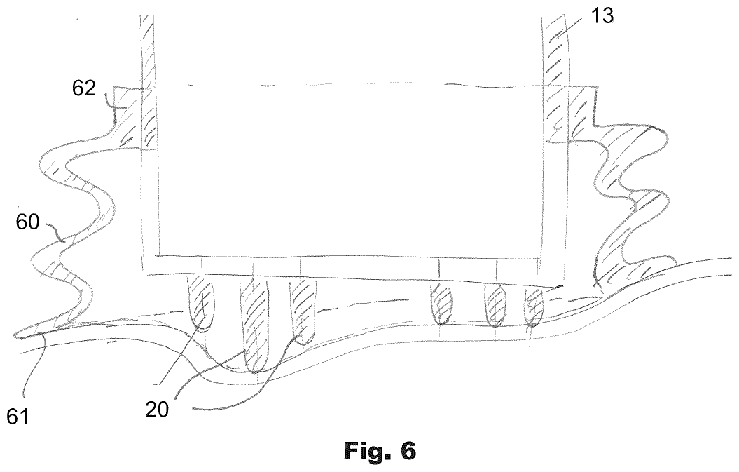

FIG. 6 shows a second exemplary embodiment, in which the insulation according to the first aspect is configured differently to the first exemplary embodiment.

Here, a flexible or deformable enclosure 60 made of a magnetically insulating material is used as an insulation that surrounds the gripper elements as a whole in the shape of a frame. In this exemplary embodiment, a bellows is provided, which is fastened to a housing of the magnetic gripper in a connecting region 62 and, from there, reaches forward to the object to be gripped, which bellows touches it with its front edge 61.

In a possible configuration, the insulation in all the configurations set out above could also consist of a magnetically conductive material as long as it is not magnetically conductively connected to the pole pieces and/or the soft-magnetic material of the gripper elements, since it thus also magnetically insulates the gripper elements from the outside and prevents other objects from adhering to the sides of the gripper elements. In this case, however, the mechanical configuration of the insulation has to ensure that it cannot itself come into contact with the side surface of the gripper elements. Furthermore, the insulation has to be prevented from becoming magnetized during operation. Optionally, the insulation is therefore made of a magnetically insulating material.

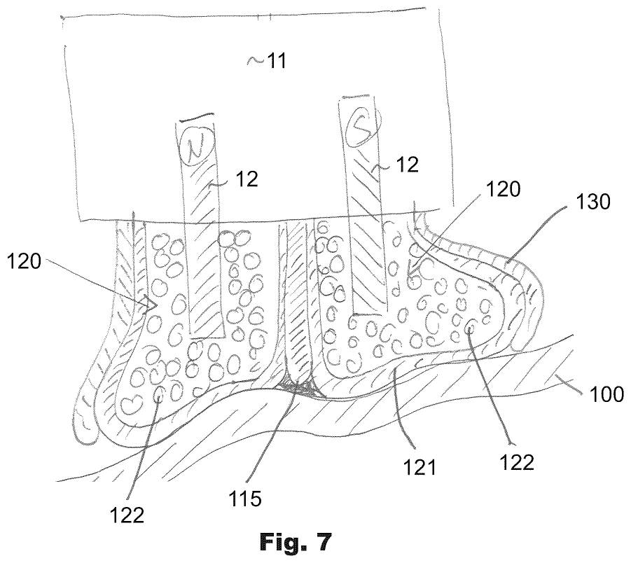

FIG. 7 to 9 show further exemplary embodiments which implement the second aspect of the present disclosure, and in which inherently rigid, but movably mounted gripper pins 20 are therefore not used as gripper elements, but deformable gripper elements 120 are used instead.

In particular, in this case, the gripper elements 120 comprise a flexible, deformable front surface 123, which therefore can be adapted and applied to the contour of the object to be gripped over its surface.

In all the exemplary embodiments shown, in this case, the gripper elements comprise a flexible sleeve 121, which is filled with a soft-magnetic granulate 122. If a magnetic field is not applied, the gripper elements can therefore be deformed.

At least in the region of the front surface 123, the flexible sleeve 121 is optionally likewise made of a soft-magnetic material, for example a knitted fabric made of soft-magnetic wires, such as a braid or chain mail.

In this exemplary embodiment, the pole pieces 12 are designed as pole pins, which extend into the space enclosed by the flexible sleeve 121 and thus into the granulate.

In a first configuration, in this case, the pole pieces can be rigidly arranged on the magnetic gripper.

Alternatively, they can be linearly movably guided on the magnetic gripper and can be preloaded into an extended position. They thus compress the granulate and ensure that the flexible sleeve 121 is completely full. Furthermore, the distance between the pole pieces and the object to be gripped which has to be spanned by the granulate is reduced.

Unlike the gripper pins used in FIG. 1 to 5, in this case, the aim of the movable arrangement of the pole pieces is not to directly touch the object to be gripped and accordingly generate a gripping contour adapted to the object. Instead, this function is performed by the granulate and the flexible sleeve. The movability of the pole pieces instead serves to compress and to reduce the distance from the object in order to increase the magnetic flux density.

In the exemplary embodiment shown in FIG. 7, the two gripper elements are magnetically insulated from one another by an insulating element 115, such that their side surfaces facing one another are magnetically separated from one another. The insulating element 115 is designed as a flexible wall, which is fastened to the side regions of the gripper elements facing one another on either side, as shown for example in FIG. 7.

Furthermore, the gripper elements 120 are enclosed by an insulation 130, which magnetically insulates its side regions from the outside. The insulation 130 can also be designed as a flexible wall, which is fastened to the side regions of the gripper elements facing outwards, as shown for example in FIG. 7.

The insulation 130 and/or 120 can, however, also be designed as a flexible insulation that is spaced apart from the gripper elements, for example in the form of a bellows comprising an inner wall for the element 120.

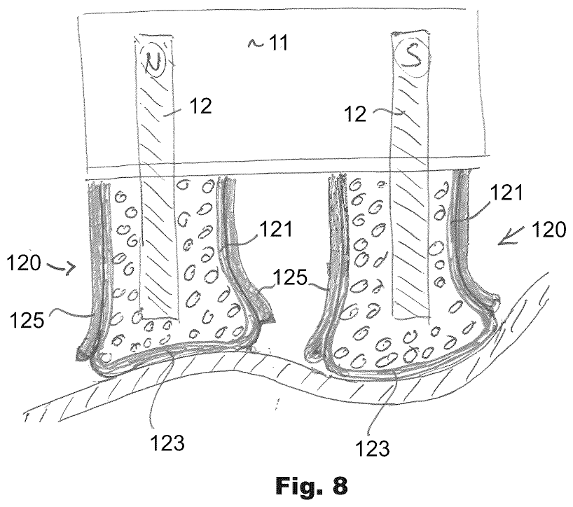

In the exemplary embodiment shown in FIG. 8, however, the individual gripper elements are each surrounded by a flexible insulation at the side, which therefore insulates the gripper elements both from one another and from the outside.

In this case, the flexible insulation can be formed by a side wall of the flexible sleeve 121 of the respective gripper elements or can be arranged on the outside thereof as an additional layer.

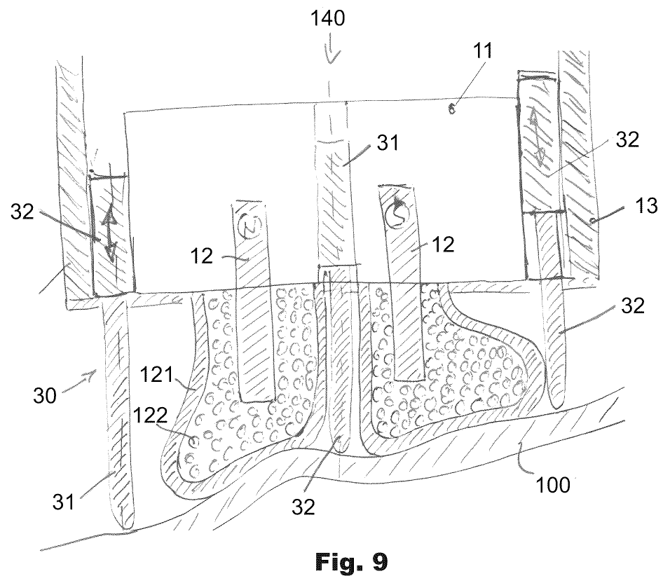

In the exemplary embodiment shown in FIG. 9, however, movably mounted magnetic pins 30 are provided as the insulation, which surround the gripper elements 120 in the same way as in the first exemplary embodiment in FIG. 1 to 5.

Furthermore, an additional central row 140 of movably mounted insulating pins 30 is used, which is arranged between gripper elements assigned to the two pole pieces and separates the gripper elements from one another.

According to the second aspect and the exemplary embodiments in FIG. 7 to 9, a magnetic gripper for a ferromagnetic workpiece is therefore provided, wherein the gripper elements can completely and freely adapt to the workpiece contour or a reference contour. For this purpose, the magnetic gripper comprises, for each gripper element, a collection container for ferromagnetic filler material (granulate, e.g. spheres), a switchable magnetic flux source of which the magnetic field strength can optionally be set as desired (field strength 0 to max.) and which comprises at least one pole shoe outside or inside the collection container and in the form of a complete gripper apparatus over at least 2 gripper elements for the north and south magnetic pole pairs.

The collection container (chambers, pouches) can consist of non-ferromagnetic or ferromagnetic material (“e.g. chain mail”).

To shield the magnetic forces, the collection containers have an insulation outside the contact surfaces.

The insulation constitutes the central element according to the first aspect of the present disclosure, since, owing to this measure, the magnetic forces only act where this is required for gripping. The insulation can e.g. be constructed by pins that can be advanced, can be clamped and are spring-loaded, and consist of non-ferromagnetic material or are provided with a non-ferromagnetic coating at least outside the housing. The pins would be advanced linearly.

Alternatively, the protective curtain could consist of an annular, closed element (e.g. rubber bellows), which likewise completely adapts to the surface contour owing to the advancing movement.

Alternatively, a resilient, dimensionally stable collection container could be produced by applying a shape-resilient protective layer to the collection container.

When it is completely full, the dimensional stability is increased. The function of complete filling can be increased by utilizing the resilience in that, after positioning the gripping apparatus on the workpiece, the pole shoes are advanced into it and, in the manner of a piston, they increase the pressure in the collection container and reduce the distance from the object to be gripped, but without the pole shoes directly touching the object and therefore providing a gripping surface. The gripping surface is instead provided by the collection container and its filling.

Once the gripper comprising the collection containers is advanced onto the workpiece or a corresponding reference surface, the shape of the collection containers completely adapts to the surface. The granulate in the collection container is ferromagnetic. Applying a defined magnetic field strength results in a memory effect of the filler in the collection container with minimal holding force at the contact points with the component or reference surface. This effect is enhanced when the granulate can interlock, in comparison with spheres. Therefore, any gripper contours can be produced and saved using a minimal magnetic force.

The aim of adapting the contour is to obtain an increased transverse force owing to the shape contour (toothing) in addition to the increased holding force (number of contact surfaces) normal to the workpiece surface.

Instead of the deformable gripper elements according to the second aspect, displaceably mounted gripper pins could also be used. The result of adapting the contour is similar, just except that it is not continuous, but at discrete intervals. The pins are freely movable in the housing and are only loosely guided on their side surfaces and are optionally preloaded by springs.

The gripper pins are made of ferromagnetic material, which is insulated in the pin region on its outside where necessary.

The special feature according to the third aspect is that, by applying the magnetic field, each of these pins becomes a temporary magnetic pole for the other pins. The pins are therefore provided with large surface areas, and the magnetic field is transmitted from pin to pin. A block is formed, which is automatically applied to the pole shoe. A clamping apparatus can be dispensed with.

For example, as a magnetically insulating material, aluminum can be used for rigid insulations and plastics material and/or rubber can be used for flexible insulations.

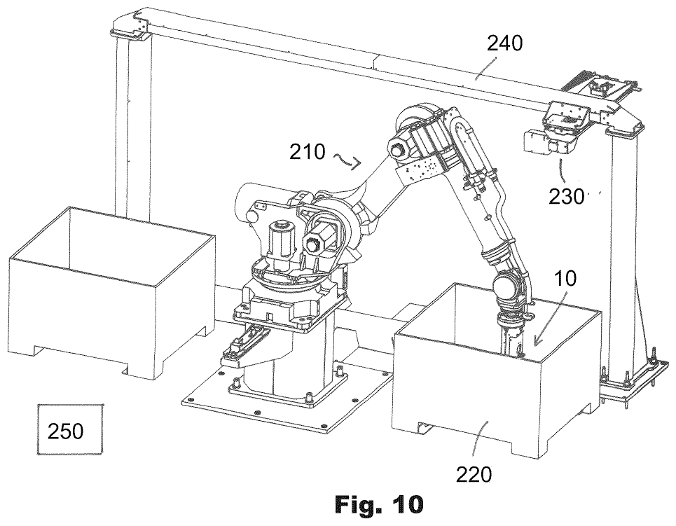

FIG. 10 shows an exemplary embodiment of a device for the automated removal of workpieces arranged in a disordered manner in a container 220, comprising an object-recognition apparatus 230 for detecting the workpieces in the container 220 and a magnetic gripper 10, as has been described above.

In this case, the magnetic gripper 10 is arranged on the handling device 210 and is moved thereby. In this exemplary embodiment, this is an industrial robot having a plurality of rotational axes, in particular having at least 6 rotational axes.

Furthermore, a schematically shown controller 250 is provided for evaluating the data from the object-recognition apparatus 230, for path planning and for actuating the handling device 210 and/or the magnetic gripper 10.

1. Magnetic gripper, comprising
a switchable magnetic flux source,
two pole pieces, which are magnetically connected to the magnetic flux source, and
at least two gripper elements, which are each magnetically conductively connected to one of the two pole pieces,
wherein the at least two gripper elements are movably and/or deformably arranged on the magnetic gripper when the magnetic flux source is switched off, such that their front surfaces form a gripping contour that can be adapted to the contour of an object to be gripped,
wherein
the magnetic gripper comprises an insulation, which surrounds the at least two gripper elements and magnetically insulates them to the side.

2. Magnetic gripper according to claim 1, wherein the insulation is movably and/or deformably arranged on the magnetic gripper at least when the magnetic flux source is switched off.

3. Magnetic gripper according to claim 1, wherein the at least two gripper elements are formed by gripper pins, which are movably mounted on the magnetic gripper.

4. Magnetic gripper according to claim 1, wherein the insulation is formed by insulating pins, which are movably mounted on the magnetic gripper and surround the gripper elements.

5. Magnetic gripper according to claim 4, wherein the insulation and/or the insulating pins is/are formed in that the gripper pins and/or the insulating pins each comprise an insulating sleeve, which surrounds a soft-magnetic core and magnetically insulates it to the side.

6. Magnetic gripper comprising
a switchable magnetic flux source,
two pole pieces which are magnetically conductively connected to the magnetic flux source, and
at least two gripper elements which are each magnetically connected to one of the pole pieces,
wherein
the at least two gripper elements each comprise a deformable front surface when the magnetic flux source is switched off, which front surface forms a gripping contour that can be adapted to the contour of an object to be gripped.

7. Magnetic gripper according to claim 6, wherein the at least two gripper elements are formed by flexible sleeves which are filled with a soft-magnetic granulate.

8. Magnetic gripper according to claim 1, wherein the insulation is formed by at least one flexible element, which surrounds the gripper elements at the side.

9. Magnetic gripper comprising
a switchable magnetic flux source,
two pole pieces which are magnetically conductively connected to the magnetic flux source, and
at least two gripper elements which are each magnetically connected to one of the pole pieces,
wherein the at least two gripper elements are movably arranged on the magnetic gripper when the magnetic flux source is switched off, such that their front surfaces form a gripping contour that can be adapted to the contour of an object to be gripped,
wherein the at least two gripper elements are formed by gripper pins which are linearly movably arranged on the magnetic gripper,
wherein
the gripper pins each comprise a guide element by means of which they are linearly movably guided on the magnetic gripper,
wherein the guide elements of at least two adjacent gripper pins are guided directly on one another and/or wherein a plurality of gripper pins arranged beside one another are assigned to at least one pole piece, the guide elements of which pins are guided on a side wall of the pole piece.

10. Magnetic gripper according to claim 9, wherein a first group of gripper pins arranged beside one another, the guide elements of which are guided on a side wall of the pole piece, and a second group of gripper pins arranged beside one another, the guide elements of which are guided on the guide elements of the first group, are assigned to at least one pole piece, and/or
wherein the magnetic gripper comprises at least one insulating pin comprising a guide element, by means of which it is guided on one of the pole pieces and/or on guide elements of other insulating pins and/or on guide elements of gripper pins.

11. Magnetic gripper according to claim 9, wherein the guide elements of the gripper pins and/or the insulating pins consist of a soft-magnetic material and/or wherein pin elements are arranged on the guide elements of the gripper pins and/or the insulating pins, wherein the front surface of said pins forms a gripping surface of the magnetic gripper on the gripper pins.

12. Magnetic gripper according to claim 9, wherein the magnetic gripper comprises a plurality of gripper pins, the guide elements of which are arranged in a spatial region provided between the two pole pieces.

13. Magnetic gripper according to claim 1, further comprising a magnetically insulating enclosure laterally surrounding the magnetic flux source and/or pole shoes and/or the mounting region for the gripper pins of the magnetic gripper.

14. Device for the automated removal of workpieces arranged in a disordered manner in a container, comprising an object-recognition apparatus for detecting the workpieces in the container and a magnetic gripper according to claim 1 for gripping and removing the workpieces from the container,
wherein the device also comprises a handling device on which the magnetic gripper is arranged, and/or a controller for evaluating the data from the object-recognition apparatus, for path planning and for actuating the handling device and/or the magnetic gripper.

15. Method for operating a magnetic gripper according to claim 1, comprising the steps of:
moving the magnetic gripper up to an object to be gripped with the magnetic flux source switched off, such that the gripper elements are moved and/or deformed by the contact with the component and form a gripping contour adapted to the component, and
at least partially switching on the magnetic flux source to fix the gripping contour and/or to grip the component.

16. Magnetic gripper according to claim 3, wherein the gripper pins are linearly movable and/or are preloaded into an extended position by spring elements.

17. Magnetic gripper according to claim 4, wherein the insulating pins are linearly movable and/or are preloaded into an extended position by spring elements.

18. Magnetic gripper according to claim 7, wherein pole pins extend into the granulate.

19. Magnetic gripper according to claim 11, wherein the pin elements have a smaller cross section than the guide elements, wherein the pin elements pass through openings in a housing of the magnetic gripper, on which the guide elements are retained, and/or wherein the guide elements comprise planar side surfaces, by means of which they are guided on one another and/or on the side surfaces of the pole pieces, wherein the guide elements have a rectangular or hexagonal cross section.

20. Magnetic gripper according to claim 12, wherein at least one group of these gripper pins is assigned to each of the two pole pieces.
